(19) United States
(12) Patent Application Publication
(10) Pub. No.: US 2007/0027910 A1
(43) Pub. Date: Feb. 1, 2007

(54) ENFORCING SECURITY ON ATTRIBUTES OF OBJECTS

(76) Inventors: Duane Fredrick Buss, West Mountain, UT (US); Dale Robert Olds, Sandy, UT (US)

Correspondence Address: SCHWEGMAN, LUNDBERG, WOESSNER & KLUTH/NOVELL, PO BOX 2938, MINNEAPOLIS, MN, 55402, US

(21) Appl. No.: 11/530,985

(22) Filed: Sep. 12, 2006

Related U.S. Application Data
(63) Continuation-in-part of application No. 10/242,007, filed on Sep. 12, 2002, now Pat. No. 7,107,538.

(51) Int. Cl. G06F 17/00

(52) U.S. Cl. 707/103 R

(57) ABSTRACT

Methods and systems are provided for enforcing security on attributes of objects. A requestor attempts to assign a value to a target attribute of a target object. The value is a reference to a third object. The target attribute includes security for assigning values and is also linked to a related third attribute associated with the third object. The security associated with the target attribute and security associated with the third attribute are both independently enforced before the assignment of the value to the target attribute is permitted to proceed.

### RELATED APPLICATION

The present application is a Continuation-In-Part of co-pending U.S. application Ser. No. 10/242,007, filed on Sep. 12, 2002 and entitled “Enforcing Security on an Attribute of an Object;” the disclosure of which is incorporated by reference herein in its entirety.

### FIELD

The present invention relates to enforcing security on attributes of objects.

### BACKGROUND

Ensuring security in a distributed computing environment is becoming increasingly complex. As soon as a security hole is detected and patched a new vulnerability is detected. Traditionally, security is enforced at various levels of abstraction within a distributed environment. For example, the Operating System (OS) is layered and includes a File System (FS) or Directory System (DS). Both the OS and the DS employ security techniques to prevent unintentional or malicious damage to the resources (e.g., hardware and/or software) of the distributed environment.

In order to decrease the coding complexity of conventional DS's the DS's are modularized at various levels of abstraction similar to the design of OS's. Accordingly, some DS's use Object Oriented (OO) design and programming methodologies. In an OO approach, resources (physical and logical), organizations, applications, users, geographic locations, and the like are encapsulated as object entities within a software module. The objects include publicly available access methods and privately available access methods. The private methods are used, in part, to enforce some security since only internal or authorized users, objects, and/or applications are permitted to process the private methods. The private methods also permit the objects to hide lower levels of coding abstraction that are associated with the objects. The public methods are published and accessible to other users, objects, and/or applications and are used to communicate with the object.

Objects also include attributes or properties that can be set or accessed through a number of the public methods associated with the objects. For example, a DS object representing a user can include an attribute called GroupMembership, where one or more values assigned to the GroupMembership attribute represent other objects and/or object groups to which the user belongs. The user object can also include an attribute that identifies the directory in which the user is to be placed upon login. Moreover, as is readily apparent to one of ordinary skill in the art, a single object can be a superset of aggregation of a multitude of other objects.

Although the OO approach for DS's implementations can enforce security attributes for accesses to the objects a security breach is readily detected. For instance, a modifier (e.g., user, application, or another object) can generate an instance of an object. The modifier has access to generate the instance of the object. While defining the instance, the modifier can provide a value for an attribute of the instance. The value can be a hard coded string constant to a different object. Moreover, the different object can be a destructive operation, such as a format hard drive operation. Furthermore, the attribute of the instance can include a forced execution value, such that the modifier can assign the format hard drive operation and force its execution upon login of a user. Conventionally, the values provided for attributes are not validated to ensure that the values are not references to other objects that the modifier is not permitted to access.

The security hole is particularly noticeable when two or more systems are interfaced with one another and have access to the same object. For example, a first system, such as a calendaring system, may permit a user with proper access rights to a conference room to freely invite other users to attend a meeting in the conference room. The conference room is represented as an object within the first system, and the conference room can include a plurality of attributes such as direction information, time-of-day limitations, date limitations, invited attendees, and the like. The calendar object can also be interfaced to other systems, such as email systems, word processing systems, and/or systems that permit values of attributes defined within the calendar object to trigger the automatic execution of an external application. With conventional designs and approaches it would be perfectly permissible for a user to invite attendees to a meeting in the conference room, since on the surface this appears to be an innocuous operation (e.g., not actually modifying an attendee's calendar). But, if values provided as attributes of the conference room are also linked with other systems, such that external applications can be automatically launched, then the user could achieve something typically not permissible. For example, the user could forcibly place an entry on an attendee's calendar, or the user could do something more destructive, such as using a second system to launch a destructive application that could do damage to resources of an attendee.

As is now apparent, there exists a need for improved techniques that enforce security on attributes of objects. This is particularly useful when objects are used by two or more different systems. Furthermore, the techniques should be flexible, practical, easy to manage, integrate, and implement.

### SUMMARY

In various embodiments, techniques for enforcing security on attributes of objects are presented. More specifically, and in an embodiment, a method for enforcing security on attributes of objects is provided. A first attribute value for a first attribute of a first object is received from a requestor. The first attribute value is a second object or a reference to the second object. Definitions for the first and second objects are accessed to determine whether the requester has a first access right to the first attribute and to also determine whether the requestor has a second access right permitting the second object to be referenced via the first attribute value within the first attribute. The second access right is associated with a second attribute of the second object. The first attribute value is permitted to be assigned to the first attribute of the first object when the definitions of the first and second objects and the first and second access rights allow.

### BRIEF DESCRIPTION OF THE DRAWINGS

FIG. 1 is a diagram of a method for enforcing security on attributes of objects, according to an example embodiment.

FIG. 2 is a diagram of another method for enforcing security on attributes of objects, according to an example embodiment.

FIG. 3 is an attribute security enforcement system, according to an example embodiment.

### DETAILED DESCRIPTION

Objects include logical software representations of users, organizations, geographic locations, software applications, hardware/software resources, and the like. The objects can be embodied and implemented using traditional OO techniques or through any standard (e.g., structured) programming technique. Objects include attributes or properties. Instances of objects are defined by rules (e.g., metadata) controlled by object schemas. The object schemas can be in any data format (e.g., Extensible Markup Language (XML), XML Schema Definition (XSD), Resource Development Framework (RDF), Extensible Style Sheets Language (XSL), and others).

Moreover, the instances of the objects are created or generated by a requestor. The requestor can be an object, user, application, and the like. In some cases the requestor is itself an automated service. The requestor accesses an object's schema to define a permissible instance of an object or to modify an existing instance of the object. Actual access to the schema may be controlled by other services, such as component services within a Directory Service (DS) or a security service. In creating or modifying an object instance, the schema will define what attributes are mandatory for the instance and what attributes are optional for the instance. Attributes may also be used to identify related attributes associated with different objects and may also be used to identify permissions (e.g., read, write, etc.) for specific operations that are to be performed on the attributes. In various embodiments of the present disclosure, the schema is accessible (directly or indirectly via another service) to the requestor through an Application Programming Interface (API) library and/or a Graphical User Interface (GUI) application.

Furthermore, in one embodiment, the present disclosure is implemented within a DS, such as NetWare, distributed by Novell, Inc. of Provo, Utah. In another embodiment the present disclosure is implemented within eDirectory®, distributed by Novell, Inc. of Provo, Utah. Of course any DS, or DS enabled application can utilize the teaching of the present disclosure to improve security. Moreover, any application that defines objects and security for those objects can benefit from the present disclosure. All such DS's and applications are intended to fall within the broad scope of the present invention.

Of course, the embodiments of the invention can be implemented in a variety of architectural platforms, operating and server systems, or applications. Any particular architectural layout or implementation presented herein is provided for purposes of illustration and comprehension only and is not intended to limit aspects of the invention.

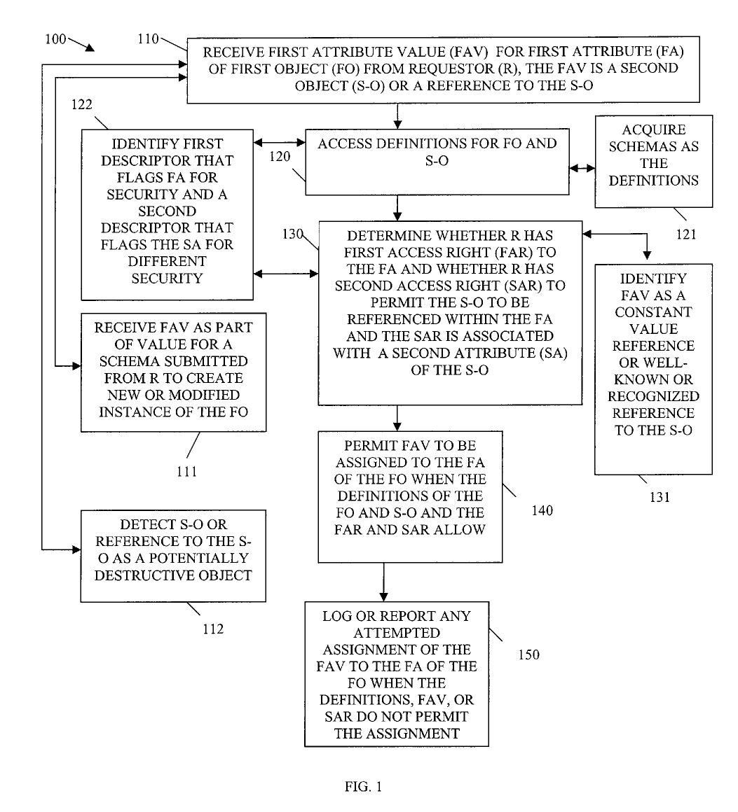

FIG. 1 is a diagram of a method 100 for enforcing security on attributes of objects, according to an example embodiment. The method 100 (hereinafter “attribute security service”) is implemented in a machine-accessible and readable medium as instructions. The instructions when executed by a machine perform the processing depicted in FIG. 1. The instructions may also be operable over a network. The network may be wired, wireless, or a combination of wired and wireless.

Initially, a requestor attempts in some manner to modify an existing instance of an object (first object). The requestor may itself be an object (requesting object) or an automated service. Again, an object is a data abstraction and encapsulation of some entity or service. Additionally, a single object may be associated with groupings of objects. So, a global directory users object may include a plurality of user objects. An object may be associated with a user, with automated applications or services, or with resources, such as directories, data stores, etc.

Objects have one or more attributes. Attributes are information or characteristics associated with a given object. For example, a user object may have a membership attribute that lists or references as part of its value another global object to which the user object belongs, such as a security group (e.g., administrators), directory users, chat groups, etc. Attributes can also have multiple characteristics, such that one particular attribute can also include security rights or permissions for predefined operations that may be performed on that particular attribute and/or may identify other related attributes associated with entirely different objects or object types.

Objects are defined according to definitions or schemas. When a schema is supplied values, the set of values for any given assignment becomes a unique instance of a particular object. So, any particular object instance has a unique set of assigned values to its attributes. Moreover, existing values for a given instance of an object can be modified to create a modified instance of that given object.

Users, automated objects, or services may assign values to attributes or modify values of a particular object instance to create new or modified instances of objects. This is done by interacting with the object schema or definitions (directly or indirectly such as through a DS or a security service). In some cases, this process may be entirely automated or may entail some degree of manual operation, such as when a graphical user interface (GUI) is interacted with by a user to assign specific values to an object schema.

The requestor modifies attribute values for target or first objects directly via a GUI or indirectly through other services or even other object representing services. The requester may itself be an object (although it does not have to be). So, if a user (requestor) is interacting with a GUI, then an identity of that user may be recognized as an object reference associated with another more global object (e.g., directory users object, email users object, etc.) where that global object includes an attribute, such as members, and the requestor's identity is associated with that attribute. In other words, the requester may be, in some cases, linked to a particular instance of a requesting object.

It is with this context that the processing of the attribute security service is now discussed with reference to the FIG. 1. The attribute security service is interposed into environments, services, or applications that permit object instances to be created or modified. As one example, eDirectory® distributed by Novell, Inc. of Provo, Utah may be modified to include the attribute security service. It is to be understood that any service, environment, platform, and/or system that permits object instances to be modified, destroyed, or created may integrate the processing of the attribute security service to achieve the beneficial security described more completely herein and below.

At 110, the attribute security service receives or detects a first attribute value for a first attribute of a first or target object. This attempted assignment of the first attribute value is received or detected as being supplied by a requester. Moreover, the first attribute value supplied by the requestor is itself a second object or a reference to a second object. So, the requester is attempting to modify a first attribute of a first object with a first attribute value that is a reference to another second object.

In fact at 111 and in an example circumstance, the attribute security service may receive or detect the presence of the first attribute value as being part of a schema for the first object that the requestor is attempting to save or submit for purposes of creating a modified instance of the first object. So, the requestor may have acquired the first object's schema, discovered the first attribute definition therein and attempted to assign the first attribute value to the first attribute field and submit or generate a modified instance of the first object. Before, this submission is permitted to take the attribute security service is alerted and inspects the first attribute value in manners discussed more completely below.

It may also be the case, at 112, that the attribute security service detects the first attribute value as being a reference to a second object, where that second object is itself potentially destructive. That is, the second object may be capable of creating, destroying, or modifying other objects. Again, this can be detected by identifying a type associated with the second object or a specific name assigned as being the second object.

At 120, the attribute security service accesses definitions the first and second objects. Access is made to determine whether the requestor requires a first access right (permissions) to the first attribute of the first object and is made to determine whether the requester requires a second access right (other permissions) to a second attribute of the second object. The second access right identifies whether the second object can be referenced within the first attribute of the first object. The first attribute and the second attribute are linked in some manner as being related to one another. So, when the first attribute value is determined as being a reference to the second object, the attribute security service inspects the first access right associated with the first attribute and discovers that a related or linked second attribute associated with the second object also has a second security right that has to be inspected before the assignment can take place to the first attribute of the first object.

In some cases, at 121, this may be done by acquiring schema definitions associated with the first object and the second object. The definitions may include, at 122, descriptors, flags or other identifiers on the attributes (first attribute of the first object and second attribute of the second object) or on the first or second object as a whole that alerts the attribute security service that security rules or rights are to be enforced before certain operations may occur with the first attribute of the first object. In particular, the first attribute of the first object is flagged within the definition of the first object with permissions, policies, rights, or rules (first access right) that the attribute security service dynamically evaluates or resolves for purposes of determining whether the requester is in fact permitted to perform the assignment of the first attribute value to the first attribute of the first object. Also, the first attribute identifies or permits the attribute security service to identify a related second attribute for the second object (value supplied by the requester). The definition or schema associated with the second object is inspected and a second descriptor or flag is detected on the second attribute, this permits the second access right to be discovered.

At 130, the attribute security service makes a dynamic and real-time determination as to whether the first attribute of the first object includes permissions (first access right) that would permit the requestor-supplied first attribute value (reference to the second object) to be assigned to the first attribute of the first object. At 130, a determination is also made as to whether the first attribute value can be assigned to the first attribute value according to permissions (second access right) associated with the second attribute of the second object. Again, at 122, this may be done via inspecting a schema for the first attribute of the first object to detect a security descriptor or flag and inspecting a schema for the second attribute of the second object to also detected a second security descriptor, whereas a different schema associated with the second attribute of the second object is inspected for a second descriptor that identifies different security (second access right) for the requester.

In some cases, the determination may be impacted by a variety of real time and dynamic determined factors. For example, at 131, the first attribute value (reference to the second object) may be identified as being a constant value and a constant value may not be permitted since it may be viewed as being a potential security threat. A constant value assignment may hard code a destructive object reference or operation into the first attribute and may not be capable of being resolved by the attribute security service. It may also be the case that the value is a well-known object reference, which is known to be destructive or harmful. Thus, well-known object reference that are potentially problematic may be used instead of or with a constant value assignment as well. So, a global security rule independent of the individual security or access rights associated with the first and second attributes may prohibit the assignment in situations where the first attribute value supplied by the requester is identified as a constant value type.

The security check is dual meaning security for the first attribute of the first object (first access right) and additional security for the second attribute of the second object (second access right) are both independently checked before the requester is permitted to assign the first attribute value (reference to the second object) to the first attribute of the first object.

Accordingly, at 140, the attribute security service permits the first attribute value (reference to the second object) to be assigned to the first attribute of the first object when the definitions of the first object and second object and the permissions (first and second access rights) allow such an assignment. Both security rules and policies (first and second access rights) are enforced before the assignment is allowed. This provides for more granular security enforcement and makes security enforceable on multiple and different attributes (first and second attributes) of objects (first and second objects) involved in any given transaction.

In an embodiment, at 150, the attribute security service may elect to log or report any attempted assignment that fails because the security (first access right) of the first attribute or security (second access right) of the second attribute did not permit or allow such an attempted assignment. That is, if the definitions of the first object and second object or the permissions (first and second access rights) of the first attribute and the second attribute deny the assignment, then the attribute security service may log the attempted assignment, deny the assignment, and report the attempted assignment to one or more other resources, objects, or services.

As an example illustration of the above dual attribute security technique, consider the following example. Suppose that a requester (Duane—a user in a DS) desires to assign an object reference of Dale (a particular instance of a second object within the DS—in this example a different user in the DS) to a first attribute (called member) to a first object (called DirectoryGroup). The schema for the member attribute (first attribute) of the first object (DirectoryGroup) includes a link or identification that it is related to another attribute (second attribute) of DS users (in this example an instance of a DS user that is identified as Dale). That related attribute may be named MemberofGroups (second attribute) within instances of DS users. Before Duane can force the assignment of Dale to the DirectoryGroup's attribute members, Duane must have permissions (first access right) to make an assignment to member attribute and must also have permissions (second access right) to the instance of MemberofGroups associated with any Dale instance that may be permissibly generated. So, Duane must have write permissions to both the members attribute of DirectoryGroup and write permissions to the MemberofGroups for the instance of Dale that Duane is trying to create. If both permissions exist then Dale is permitted to make the assignment of Duane to the members of the DirectoryGroup; otherwise Dale is not permitted to make the assignment and the attempt to make the assignment is logged and/or reported to other resources or objects.

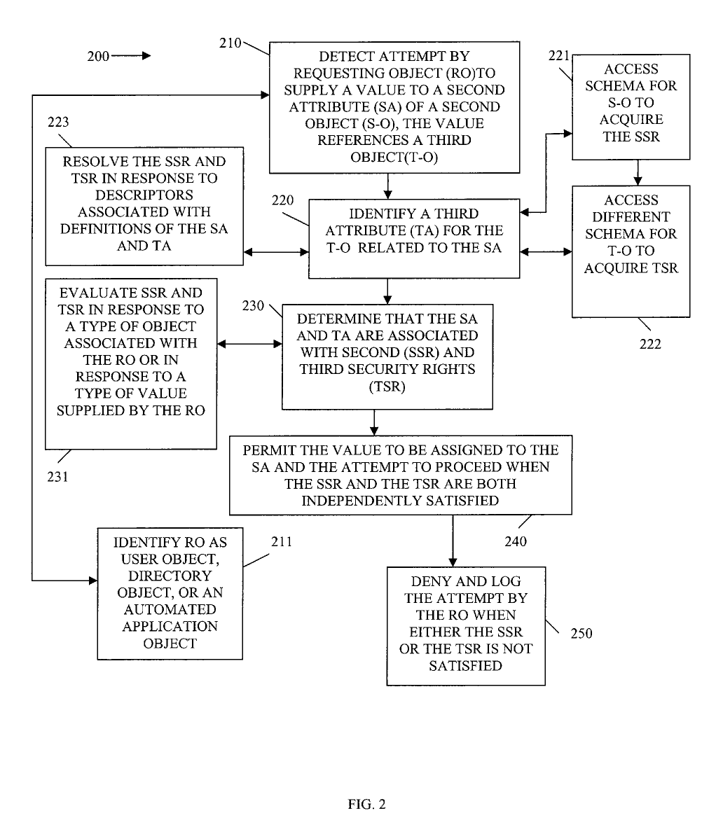

FIG. 2 is a diagram of another method 200 for enforcing security on attributes of objects, according to an example embodiment. The method 200 (hereinafter “security service”) is implemented in a machine-accessible and readable medium and is operational over a network. The security service is implemented as instructions that when executed by a machine perform the processing depicted in FIG. 2. Moreover, the instructions are operable over a network connection and the network connection may be wired, wireless, or a combination of wired and wireless. The security service presents an alternative perspective to the attribute security service represented by the method 100 of the FIG. 1 (described above).

At 210, the security service detects an attempt by a requesting object (requester) to supply a value to a second attribute of a second object (target object). The value supplied is actually a reference to yet another third object. According to an embodiment, at 211, the security service may recognize or identify the requestor as being a specific type of object, such as but not limited to, a user object, a directory object, an automated application or automated service object, etc.

At 220, the security service identifies a third attribute associated with the third object that is related, linked, or associated with the second attribute of the second object.

In an embodiment, at 221, the security service accesses a schema associated with the second object or the second attribute and discovers the related link to the third attribute of the third object and further discovers a second security right associated with the second attribute. The second security right has to be satisfied before the requestor is permitted to make the assignment of the value (reference to the third object). This linkage or relatedness between the second attribute and the third attribute also prompts the security service, at 222, to inspect a different schema for the third object or the third attribute to discover another third security right, which also has to be enforced before the assignment of the value (reference to the third object) can be made by the requester.

At 230, the security service has determined that the third attribute is related to the second attribute, and the security service determines a second security right for the second attribute and a third security right for the third attribute. In some cases, the presence of the second and third security rights may be detected by descriptors or flags associated with definitions, such as schemas, for the second attribute and the third attributes, as discussed above.

Furthermore, at 231, once the second and third security rights are obtained, the security service can dynamically evaluate or inspect them both independent of the other to decide whether the value (reference to the third object) supplied by the requestor may be assigned to the second attribute of the second object. It may be that the second security right permits an object reference assignment but that the third security right does not permit such an assignment to be made to the third attribute, and in such a situation the assignment of the value (reference to the third object) is not permitted to be made to the second attribute of the second object.

Accordingly, at 240, the security service may permit the value (reference to the third object) to be assigned and the attempt may proceed when both the second and third security rights are both independently satisfied.

The second and third security rights may include a variety of conditional logic or rules that are capable of being dynamically evaluated or evaluated in real time. For instance, at 231, the security service may evaluate the second and third security rights in response to a particular type of object associated with the requester or in response to a particular type of value associated with the supplied value. These and other factors may impact whether the security rights permit assignments to the second attribute of the second object.

In an embodiment, at 250, the security service may deny and log the attempted value assignment (reference to the third object) to the second attribute of the second object when either the second or third security right is not satisfied.

It is also noted that in some cases global security rights may be evaluated in addition to the second and third security rights. A global security right may be associated with the requestor as a whole, the second object as a whole, the third object as a whole, and/or with particular groupings or combinations of objects.

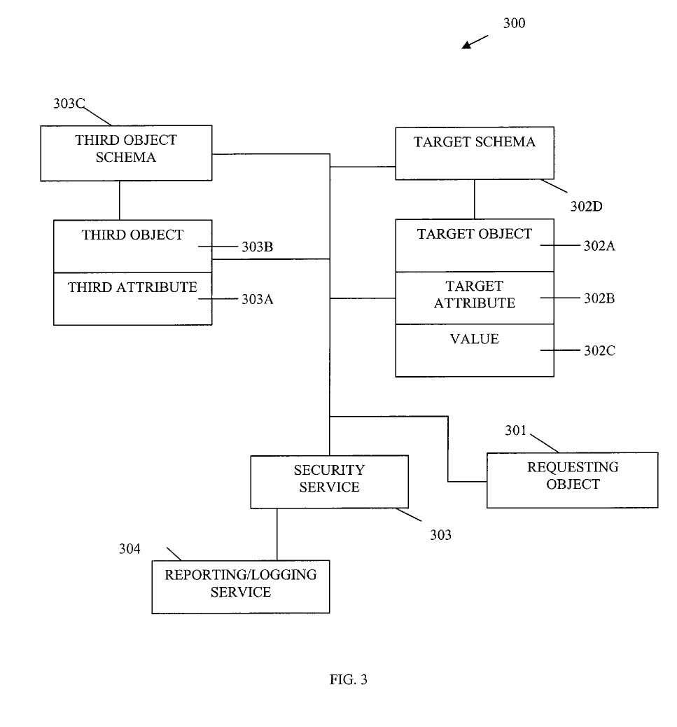

FIG. 3 is an attribute security enforcement system 300, according to an example embodiment. The attribute security enforcement system 300 is implemented in a machine-accessible and readable medium and is accessible over a network. The network may be wired, wireless, or a combination of wired and wireless. According to an embodiment, the attribute security enforcement system 300 implements, among other things, the attribute security service and the security service represented by the methods 100 and 200 of the FIGS. 1 and 2, respectively.

The attribute security enforcement system 300 includes a requesting object (requester) 301, a target object 302A, and a security service 303. In some cases, the attribute security enforcement system 300 also includes a reporting or logging service 304. Each of these and their interactions with one another and other components will now be discussed in turn.

The requestor 301 may be a user object, a directory services object, an application object, or an automated service object. The requestor 301 attempts to make an assignment of a value 302C to a target attribute 302B of the target object 302A. This may be done directly or it may be done indirectly, such as when the requestor enlists the aid of another service, such as but not limited to a sub service of a DS or other service.

The target object 302A includes a target attribute 302B and the target attribute 302B is the component that the requester 301 desires to supply a value 302C. The value 302C is actually a reference to a third object 303B. The third object includes a third attribute 303A.

The security service 303 ensures that a target attribute security right associated with the target attribute 302B of the target object 302A permits the assignment of the value 302C and also simultaneously ensures that a third attribute security right associated with third attribute 303A of the third object 303B also permits the assignment of the value 302C.

Example processing associated with the security service 303 was presented above with reference to the attribute security service and the security service represented by the methods 100 and 200 of the FIGS. 1 and 2, respectively.

According to an embodiment, the attribute security enforcement system 300 may also include a third schema 303C and target schema 302D. The schemas 303C and 302D define the objects 303B and 302A, respectively. The security service 303 may inspect the target object schema 302D to identify a descriptor or flag that alerts the security service 303 to the target attribute security right associated with the target attribute 302B. Similarly, the security service 303 may inspect the third object schema 303C to identify a descriptor or flag that alerts the security service 303 to the third attribute security right associated with the third attribute 303A.

The security service 303 dynamically evaluates the target and third attribute security rights for purposes of determining whether one or both permits the assignment of the value 302C to the target attribute 302B of the target object 302A. In some embodiments, the security rights may be dependent on a variety of factors, such as but not limited to a type of value supplied by the requester 301 and a type of object associated with the requestor 301. Examples of these were also described in detail above with reference to the methods 100 and 200 of the FIGS. 1 and 2, respectively.

The security service 303 permits the assignment of the value 302C when both the target attribute security right and the third attribute security right are satisfied. Moreover, in some cases the security service 303 may decide that the assignment of the value 302C is still not permissible when a global security rule or right trumps the transaction. For example, the value 302C may be detected as being a reference to a destructive object or a constant value type that may be a destructive object and the security service 303 may decide based on an evaluation of a global security rule that the assignment of the value 302C is impermissible.

According to an embodiment, the attribute security enforcement system 300 may also include a reporting or logging service 304. The reporting or logging service 304 may be interfaced to or be a part of the security service 303. When an attempted assignment is denied, the reporting or logging service 304 may log and report information associated with the failed attempt to supply the value 302C.

It is now appreciated, how security may be granularly enforced on attributes of multiple objects. This removes potential security holes and provides for enhanced object security within object environments.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving a first attribute value for a first attribute of a first object, wherein the first attribute value is received from a requestor, wherein the first attribute value is a second object or a reference to the second object;
accessing definitions for the first and second objects to determine whether the requestor has a first access right associated with the first attribute and whether the requestor has a second access right permitting the second object to be referenced via the first attribute value within the first attribute, wherein the second access right is associated with a second attribute of the second object; and
permitting the first attribute value to be assigned to the first attribute of the first object when the definitions of the first and second objects and the first and second access rights allow.

2. The method of claim 1, wherein receiving further includes receiving the first attribute value as a value provided from a first object schema submitted by the requester to create a new or modified instance of the first object.

3. The method of claim 1, wherein receiving further includes detecting the second object or the reference to the second object as a potentially destructive object.

4. The method of claim 1, wherein accessing further includes acquiring schemas as the definitions for the first and second objects.

5. The method of claim 1 further comprising, identifying a first descriptor that flags the first attribute to be checked for security and a second descriptor that flags the second attribute to be checked for different security.

6. The method of claim 1 further comprising, identifying the first attribute value as a constant value reference or well-known or recognized reference to the second object.

7. The method of claim 1 further comprising, logging or reporting an attempted assignment of the first attribute value to the first attribute of the first object when the first access right or the second access right do not permit the assignment.

8. A method, comprising:
detecting an attempt by a requesting object to supply a value to a second attribute of a second object, wherein the value references a third object;
identifying a third attribute associated with the third object that is related to the second attribute;
determining that the second attribute and third attribute are associated with second and third security rights;
permitting the value to be assigned to the second attribute and the attempt to proceed when the second and third security rights are both independently satisfied.

9. The method of claim 8 further comprising, denying the attempt and logging the attempt by the requesting object when either the second security right or the third security right is not satisfied.

10. The method of claim 8 further comprising, accessing a schema associated with the second object to acquire the second security right for the second attribute.

11. The method of claim 10 further comprising, accessing a different schema associated with the third object to acquire the third security right.

12. The method of claim 8 further comprising, identifying the requesting object as a user object, a directory object, or an automated application object.

13. The method of claim 8 further comprising, evaluating the second and third security rights in response to a type of object associated with the requesting object or in response to a type of value supplied by the requesting object.

14. The method of claim 8, wherein determining further includes resolving the second and third security rights in response to descriptors associated with definitions of the second attribute and the third attribute.

15. A system, comprising:
a requesting object;
a target object having a target attribute; and
a security service that validates whether a value supplied by the requesting object to modify the target attribute of the target object is permissible in view of a target attribute security right and in view of a third attribute security right associated with third attribute of a third object, wherein the value that is attempting to be assigned to the second attribute by the requesting object is a reference to the third object and wherein the second attribute and the third attribute are related to one another.

16. The system of claim 15 further comprising:
a target schema that defines the target object, the target attribute, and the target attribute security right; and
a third object schema that defines the third object, the third attribute, and the third attribute security right;
wherein the security service is to inspect the target schema and the third object schema when the requesting object attempts to assign the value to the target attribute and wherein the target schema identifies the third attribute of the third object schema as being related to the target attribute of the target schema.

17. The system of claim 15, wherein the presence of the target attribute security right is flagged with a target descriptor in the target schema and the presence of the third attribute security right is flagged with a third object descriptor in the third object schema.

18. The system of claim 15, wherein the target attribute security right and the third attribute security right are dependent upon a type of value supplied by the requesting object or a type of object associated with the requesting object.

19. The system of claim 15 further comprising, a reporting or logging service that reports or logs information associated with a failed attempt to supply the value.

20. The system of claim 15, wherein the third object is identified as a potentially destructive object, and wherein the security service denies the assignment of the value to the target attribute irrespective of the target attribute security right and the third attribute security right in response to a global security rule.
